(19) United States
(12) Patent Application Publication
(10) Pub. No.: US 2004/0231238 A1
(43) Pub. Date: Nov. 25, 2004

(54) Item for the cultivation of an agricultural plantation and method for making said item

(76) Inventors: Andrea Baggio, Padova (IT); Nicola Baggio, Padova (IT)

Correspondence Address: YOUNG & THOMPSON, 745 SOUTH 23RD STREET, 2ND FLOOR, ARLINGTON, VA, 22202, US

(21) Appl. No.: 10/489,263

(22) PCT Filed: Sep. 5, 2002
(86) PCT No.: PCT/IB02/03587

(30) Foreign Application Priority Data
Sep. 12, 2001 (IT) BO2001A000545

(51) Int. Cl. A01C 1/04

(52) U.S. Cl. 47/56

(57) ABSTRACT

An item for the cultivation of agricultural crops, in particular vegetables, aromatic plants and herbs, comprises a mat or belt made of biodegradable material that can be placed directly over the soil and has mulching properties. The mat or belt has incorporated in it a plurality of plant structures from which the agricultural crop grows or is propagated. More specifically, the item according to the invention comprises a layer (12) made of biodegradable material having a lower surface constituting the face that comes into contact with the soil in which the crop plant grows, and a second layer (14) made of biodegradable material which during use, is placed over the first, soil contact layer and constitutes the means for retaining the plant propagative structures, and through which the plants grow above ground.

### TECHNICAL FIELD

The present invention relates to an item for the cultivation of agricultural crops, in particular vegetables, herbs and aromatic plants.

### BACKGROUND ART

Traditionally, the soil where an agricultural crop is to be cultivated must be adequately prepared prior to sowing in order to eliminate nuisance weeds.

Indeed, one of the most strongly felt problems in the agricultural field today is the use of chemicals to eliminate weeds and the use of weedkillers in general.

This problem, which is felt generally in the entire vegetable farming sector, is felt particularly in the areas of biological or natural farming.

According to the latest research in the area of biological farming, one of the most pressing requirements of the farming sector is the total elimination of chemical synthesis products from farming practices without lowering yields from their currently high levels.

At present, however, these requirements are difficult to conciliate since the elimination of chemical weedkillers, or at least the reduction in their use, inevitably leads to an increase in the presence of nuisance weeds, which compete with crops and reduce yields. This means that, to maintain yields, farmers are obliged to employ more labour to destroy the weeds, which in turn raises production costs to unsustainable levels.

These conflicting requirements, that is to say, the need for crop production practices that are as “clean” and environment-friendly as possible and the need for sufficiently high yields at reasonable costs have not so far found satisfactory solutions. Indeed, the biological farming sector has long since adopted a compromise solution where crop treatments with chemicals are considered acceptable within defined limits and using only a restricted range of expressly authorised chemical substances.

Another practice that has been widely adopted is that of sterilising the soil at high temperatures which involves flaming the top layer of the soil in order to sear the young plants and the propagative structures of the nuisance weeds. Although flaming treatments have the virtue of eliminating the need for chemical weedkillers, they have the disadvantage of impoverishing the soil by destroying useful biological organisms and have fallen into disgrace especially among the most active supporters of biological or natural farming practices.

### SUMMARY OF THE INVENTION

In order to meet the above mentioned requirements, the present invention provides an item for the cultivation of agricultural crops, in particular vegetables, herbs and aromatic plants, characterised in that it comprises a mat of biodegradable material having mulching properties and designed to be placed on the soil, the mat having incorporated in it a plurality of plant structures from which the agricultural crop grows or is propagated.

The item according to the invention, by being placed on top of the soil, inhibits the growth of young weed plants that are covered and thus suffocated by it, and at the same time promotes the growth of the crops whose propagative structures are incorporated in it.

This makes the use of chemical weedkillers largely unnecessary and permits the obtaining of crops that are wholly “biological” and that meet current consumer requirements.

The present invention also relates to a method for making the item.

The secondary claims relate to other advantageous aspects of the item according to the present invention.

### DESCRIPTION OF THE DRAWINGS

The technical characteristics and advantageous aspects of the invention are apparent from the detailed description which follows, with reference to the accompanying drawings which illustrate preferred embodiments of the invention provided merely by way of example without restricting the scope of the inventive concept, and in which:

FIG. 1 is a top view of a part of a ready-made mat according to a first preferred embodiment of the present invention;

FIG. 2 is a cross section of a part of the ready-made mat according to the first preferred embodiment of the present invention;

FIG. 3 is a schematic view illustrating the method for making the ready-made mat according to the first preferred embodiment of the present invention;

FIG. 4 is a schematic perspective view of a vegetable crop grown with the mat according to the present invention;

FIG. 5 is a cross section of a part of the ready-made mat according to the second preferred embodiment of the present invention;

FIG. 6 is a top view of a part of the ready-made mat according to a third preferred embodiment of the present invention;

FIG. 7 is a top view of a part of the ready-made mat according to a fourth preferred embodiment of the present invention.

### DETAILED DESCRIPTION OF THE PREFERRED EMBODIMENTS OF THE INVENTION

The accompanying drawings illustrate a first preferred embodiment of the item for the cultivation of agricultural crops according to the present invention.

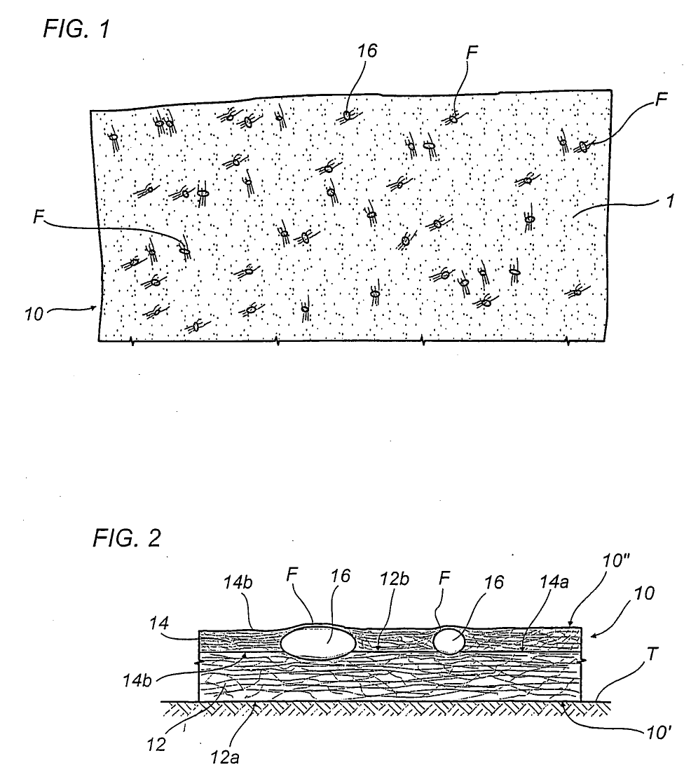

The item comprises a mat 10, in the form of a biodegradable substrate, extending mainly in length and width and incorporating a plurality of plant organisms from which the agricultural crop grows or is propagated, and which, as illustrated in FIGS. 1 and 2, consist of seeds 16, that germinate and grow into respective plants 18 (shown in FIG. 4) forming part of the agricultural crop.

As illustrated, the mat 10 presents a face 10′ which is placed in contact with the soil T and through which the roots of the crop plants grow downwards, and an opposite face 10″ through which the crop plants grow upwards above the ground.

More specifically, as illustrated in FIGS. 1 to 3, the mat which has incorporated in it the seeds or other propagative plant structures, comprises a first layer 12 made of biodegradable material and having a lower surface 12a, which is in direct contact with the soil, and an upper surface 12b on the side of it opposite the lower surface 12a.

Advantageously, this first layer of the mat 12 is made of fabric which enables the seeds, or seedlings in it to easily put out roots into the soil below. More specifically, the fabric consists of a non-woven fabric, which facilitates assembly of the mat, as explained below, and whose density and consistency are such as not to obstruct the roots of the young crop plants.

Further, the fabric is preferably made of viscose fibre which is advantageously biodegradable. The viscose fibre is a cellulose fibre of plant origin which is completely biodegradable and does not in any way pollute or harm the soil on which it is placed.

According to one advantageous aspect of it, the item according to the present invention has mulching properties, such that the weeds under the mat are prevented from growing and infesting the crop planted on the mat itself. To achieve the mulching effect, the soil contact layer 12 in this preferred embodiment of the mat is advantageously made in a suitable weight, ranging from 10 to 200 g/m².

More specifically, this mulching effect might be obtained with a bottom layer 12 whose weight ranges from 15 to 200 g/m², preferably from 30 to 150 g/m², and which is made from a viscose fibre with a titre range of 1 to 6 dtex. The bottom layer 12 might also have a weight ranging from 10 to 200 g/m², preferably from 15 to 130 g/m², and be made from a viscose fibre with a titre range of 1.5 to 3.1 dtex.

Preferably, however, the weight of the bottom, soil contact layer is between 40 and 150 g/m², ideally between 40 and 100 g/m², which provides an optimum mulching effect and a good degree of biodegradability in a reasonably short space of time.

The mat also comprises a second layer 14 made of biodegradable fabric placed over the first, soil contact layer 12, and having a lower surface 14a which is attached to the upper surface 12b of the first layer, and an upper surface 14b, which forms the upper surface of the mat from which the parts 20 of the plants 18 grow above ground.

The second layer 14 is attached to the bottom, first layer in the manner described in more detail below.

In the present preferred embodiment of the mat, the second layer is also advantageously made from a non-woven fabric, in particular, viscose fibre.

The second layer of fabric 14 is designed to retain the seeds 16 or plant propagative structures within the mat 10.

Advantageously, the weight of the layer 14 ranges from 10 to 80 g/m² according to the size of the seeds or other plant reproduction units, so as to provide an effective retaining action without excessively covering them and slowing the growth of the plants, as described in more detail below. Thus, for crop species with a large seed or propagative structure, a mat having a weight at the upper end of the above mentioned range is used.

More specifically, the upper layer 14 has a weight ranging from 15 to 80 g/m², and is made from a viscose fibre with a titre range of 1 to 6 dtex. The upper layer 14 might also have a weight ranging from 10 to 80 g/m², and be made from a viscose fibre with a titre range of 1.5 to 3.1 dtex. Preferably, however, the weight of the upper layer is between 30 to 40 g/m², so that the seeds can take root but are not excessively covered. Although the layers of the ready-made mat according to the preferred embodiment of the present invention are preferably and advantageously made from non-woven viscose fibre fabric, other biodegradable materials, such as flax, might be used for one or both of the layers of the ready-made mat.

Other natural fibres that might be used to make one or more layers of the mat are cotton, jute, and hemp, as well as other natural polymers such as cellulose acetate and elastodiene.

One or more layers of the mat might also be made from abaca, sisal, cantala, ramie, coconut, caroa, kenaf, roselle, urena or kapok fibres.

The first and second layers of the mat might even comprise the natural fibres of broom or sorghum.

As a non-restricting example of the viscose fibre that may be used, the fibre known as “SWELAN Viscose staple fibre”, made by the Swedish company Svenska Rayon AB, may be mentioned.

The viscose fibre mat according to the invention is advantageously biodegradable over 2 to 4 months after being placed on the soil. Once one crop has been harvested, the field may quickly and easily be planted with another crop. The high degree of biodegradability of the mat means that the mat will rapidly decompose into the soil.

As mentioned above, the mat according to the invention incorporates a plurality of plant structures, preferably the propagative structures of an agricultural crop, which as illustrated consist of seeds 16 that germinate and grow into plants forming the agricultural crop.

Preferably, the seeds 16 are the propagative structures of crop plants chosen from the group comprising lettuce, rocket, corn salad, valerian, endive, parsley, basil, carrot, asparagus, tomato, aubergine, courgette, cucumber, watermelon, melon, sage, spinach, rosemary, sweet pepper, cabbage, turnip, chicory, artichoke, peas, beans, string beans, radish, beet, cress, pumpkin, fennel, onion, leek.

Although the crops listed above are the most suitable, other crop species might also be cultivated.

Depending on the crop species to be cultivated, the seeds or propagative plant structures are distributed in the mat in a density ranging from just a few specimens per square metre of mat to around 8.000 seeds per square metre of mat. The distribution of the crop plants over the mat must not be excessively dense or the growth of the plants, and hence crop yields, will be adversely affected. For example, if the mat is used to cultivate rocket, whose seeds are extremely small, one square metre of the mat is sufficient to plant around 8.000 seeds. The optimum number of seeds therefore varies according to the crop species to be cultivated. In the case of valerian, 1.500 seeds per square metre of mat are preferably used, whereas, for the cultivation of carrots, one square metre of mat preferably accommodates 150 seeds, although up to 250 seeds may be planted in one square metre. For watermelon, on the other hand, the preferable density in one square metre of the mat is just 4 seeds.

The mat according to the invention produces excellent crops of broad-leaved vegetables such as chicory, endive, valerian, rocket, spinach and lettuce, in their different varieties, which benefit from the fact that they are planted near the surface of the upper layer of the mat. Plant growth would otherwise be stunted or even suppressed altogether.

In practice, the plant propagative structures are distributed in the mat asymmetrically with respect to the total thickness of the mat. Thus, the plant propagative structures are placed much nearer to the upper face of the mat than they are to the lower face.

According to another aspect of the invention, the layers making up the mat have different properties and, for the purposes of mulching, the bottom layer that comes into direct contact with the soil is heavier and thicker than the upper layer where the seeds or other propagative structures are planted.

The substrate or mat according to the invention thus accommodates the crop propagative structures above the soil in such a way that they can germinate, take root, grow and flourish. At the same time, nuisance weeds present in the soil are prevented from growing by the mat which is placed on top of the soil over them. That means that the crops give high yields without resorting to soil treatments with chemical weedkillers.

As shown in FIG. 2, the seeds 16 are incorporated in the non-woven fabric during the needlepunching process (explained in more detail below) in such a way that they are withheld by just a few fibres F in the retaining layer 14 in a position very near the surface of the mat. This arrangement of the seeds 16 is extremely advantageous. Indeed, this type of arrangement is of decisive importance for the growth of broad-leaved vegetables such as the above mentioned rocket, chicory, endive, valerian, and other salad vegetable crops. If the seeds were planted too deeply in the retaining layer, the leaves would become entangled in the fibre, thus stunting initial growth and inhibiting correct development of the plant.

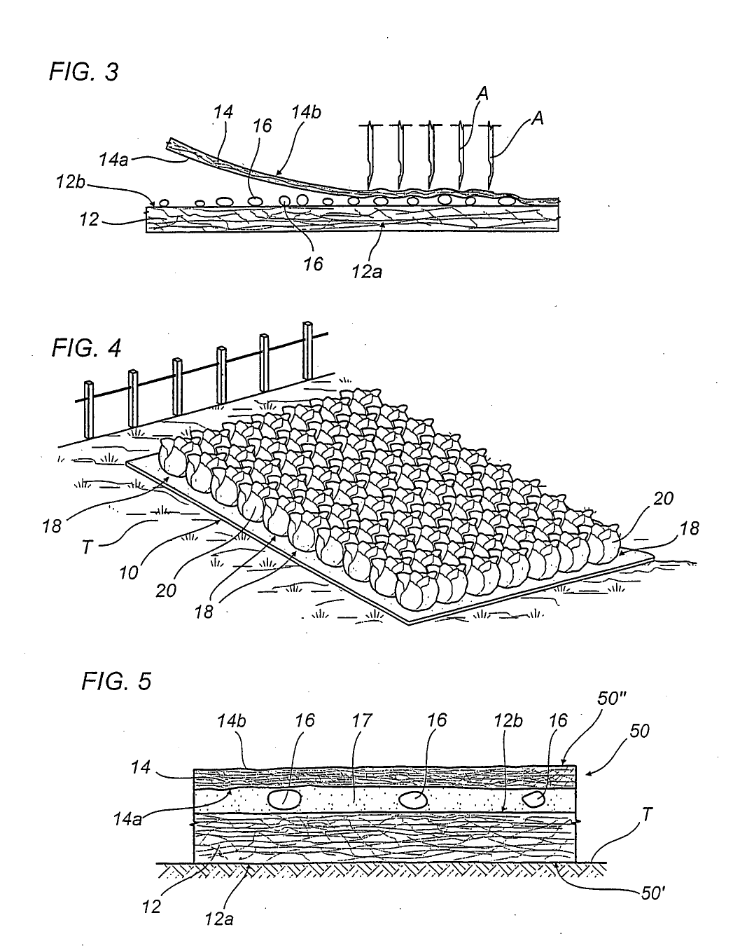

As shown in FIG. 3, which schematically illustrates the process used to manufacture the mat according to the invention, the first and second layers of non-woven fabric are bonded to each other by needlepunching.

In the process used to make the mat according to the invention, the layer 12, that is, the layer designed to come into direct contact with the soil, is fed forward while the seeds 16 are either scattered over it at random or placed on it in rows or according to another predetermined geometrical pattern. The upper layer 14 of the mat, designed to remain on top, is then placed over the layer 12 in such a way that the seeds 16 are sandwiched between the two layers.

This is followed by a needlepunching step which causes the fibres of one fabric layer to become entangled in the fibres of the other layer, thus bonding or joining the two layers together.

In practice, the needles, illustrated schematically and labelled A in FIG. 3, are punched from the top down through the upper layer 14 and into the lower layer 12 of the mat so as to push the fibres of the upper layer into the fibres of the lower layer. This has a slight flattening effect on the upper layer 14, causing the seeds 16 to also be pushed slightly upwards into the upper layer 14.

The punching needles A are inserted into the mat by successive blows. More specifically, the needlepunching machine used applies 100 blows a minute on the mat.

For optimum insertion of the seeds into the upper layer, the density of the needles used for the needlepunching operation is between 5.000 and 100.000 needles/m² working on a mat that moves continuously at a feed speed of between 2 and 25 metres a minute. This needlepunching density provides a good entangling action between the layers without damaging the seeds. Thus, in each square centimetre of the mat, moving at a speed of between 2 and 25 metres a minute, the number of needle insertions ranges from 2 to 1.500 per square centimetre and the needles penetrate to a depth of between 0.2 and 5 cm.

In an especially preferred embodiment, the needle density is around 20.000 needles per square metre, which means that the needles are inserted about 120 times in each square centimetre of the mat while the mat moves continuously at a feed speed of around 7 to 8 metres a minute. Particularly in the case of plants with small seeds, such as rocket, chicory and valerian, and aromatic plants and herbs in general, this has proved to be the optimal density not only to achieve a good bond between the different layers of the mat but also, as illustrated in FIG. 2, to enable the layer 14, which remains on top, to effectively retain the seeds on it while at the same time leaving them substantially uncovered. The seeds are thus retained by only a small number of the fibres F and can grow into a broad-leaved plant without any obstacles from the upper layer 14. This type of needlepunching can also be used for other agricultural crop species.

According to another advantageous aspect, the item according to the invention comprises a material which provides a mulching effect and/or which keeps the plant propagative structure wet.

This material preferably takes the form of an interposed layer between the aforementioned first and second layers of the mat.

According to a second preferred embodiment of the item according to the invention, illustrated in FIG. 5, the ready-made mat 50 includes a certain quantity of meal 17 of plant origin.

The plant meal is placed between the lower layer 12 and the upper layer 14 in a quantity of between 10 and 700 g/m², preferably between 10 and 400 g/m², so as to make the item according to the invention lighter and easier to handle.

The plant meal makes it possible to maintain conditions of ideal humidity around the seed or propagative structure 16, thus promoting its germination.

This type of meal is totally biodegradable and does not damage the soil. Acting in conjunction with the lower layer of the mat which is in contact with the soil, the plant meal contributes to the mulching effect preventing the growth of nuisance weeds.

Moreover, thanks to the use of a plant meal, the lower layer of the mat can be made smaller, biodegradability is improved because the mat decomposes in less time, and the production cost of the mat is reduced.

Beech flour is one type of plant meal that might be used for this purpose.

It will be understood, however, that the plant meal can be substituted or supplemented with any other type of material in the form of pellets, powder, wood chips or in any other suitable form, preferably of plant origin, for example sawdust from any plant species.

The meal, or pellets or powder used for this purpose should preferably be made from a material of biological origin from natural organisms that have not been treated with chemicals during their life cycle.

In the process for the manufacture of the item according to the invention, the plant meal, pellets or similar material, is placed on the lower layer either before or after the seeds or propagative plant structures are positioned on the lower layer. If positioned after, the resulting mat will retain humidity for the seeds or propagative plant structures to a greater extent.

The mulching and/or humidifying material might also consist of an inert material suitable for the purpose. For example, any authorised inert material for agricultural purposes might be used.

In an especially preferred embodiment, the inert mulching and/or humidifying material is clay, particularly bentonite, which has a high water retention capacity and is therefore advantageous when this property is useful for the type of crop to be cultivated. Further, bentonite advantageously possesses good mulching properties.

To help retain water and keep temperature and humidity around the item according to the invention at a constant level, a sheet of suitable material might be placed over it once it has been placed on the soil; for this purpose a sheet of material with a certain degree of permeability to water might be used.

In an example of a practical application of the invention, a mat one metre wide was laid like a continuous belt on tilled, level land. The mat comprised a lower layer made of non-woven viscose fabric weighing from 50 to 60 g/m² and an upper layer, also of non-woven viscose fabric, in this case weighing from 30 to 40 g/m². A viscose fibre known as “SWELAN Viscose staple fibre”, made by the Swedish company Svenska Rayon AB, was used. Rocket seeds were scattered between these two layers in a quantity of 8.000 seeds per square metre. After bonding the two layers together by needlepunching using 20.000 needles per square metre applied to the mat moving at an advancing speed of around 7 to 8 metres a minute, a large number of the seeds were only partially covered by the seed retaining layer.

The land on which the mat was placed had not been previously treated with any weedkiller. After being laid, the mat was watered regularly according to the requirements of the specific crop species concerned. The rocket seeds germinated in very large numbers and almost all of the seedlings grew into fully developed plants. Indeed, the rocket plants yielded four harvests at intervals of approximately 25 to 40 days from each other and at no time were weeds found among the crop of rocket leaves.

After this first crop, the land was tilled and levelled again and another mat according to the invention was placed on it.

Even the crop planted using another mat according to the invention on the same land will not have weed problems, whether it is of the same plant species as the crop before it or whether it is of another plant species.

In another practical application of the invention, a mat one metre wide was laid like a continuous belt on tilled, level land. The mat comprised a lower layer made of non-woven viscose fabric weighing from 30 to 40 g/m², an upper layer, also of non-woven viscose fabric weighing from 30 to 40 g/m², and an interposed layer of mulching, humidifying material consisting of a plant meal of the type described above. A viscose fibre known as “SWELAN Viscose staple fibre”, made by the Swedish company Svenska Rayon AB, was used. Rocket seeds were scattered between these two layers in a quantity of 8.000 seeds per square metre. After bonding the two layers together by needlepunching using 20.000 needles per square metre applied to the mat moving at a speed of around 7 to 8 metres a minute, a large number of the seeds were only partially covered by the seed retaining layer.

After being laid on the soil, the mat was watered regularly according to the requirements of the specific crop species concerned. The rocket seeds germinated in very large numbers and almost all of the seedlings grew into fully developed plants. Indeed, the rocket plants yielded four harvests at intervals of approximately 25 to 40 days from each other and at no time were weeds found among the crop of rocket leaves.

The ready-made mat according to the invention is highly biodegradable and thus does not have any harmful effects on the soil. The mat eliminates the problems caused by nuisance weeds. Furthermore, the mat permits the obtaining of high yields of the cultivated species since the seeds are distributed in it according to optimum density and spacing and also because, after germination, the seedlings and plants do not have to compete with weeds for growing factors.

Compared to traditional field cultivating methods, the mat according to the invention gives a much higher seed germination yield (that is to say, the percentage of the seeds that germinate and grow into crop plants). In one application example, the mat according to the invention gave a seed germination yield of 70% of the seeds used, compared to the 50% seed germination yield given by traditional cultivating methods where the seeds are sown directly in the soil.

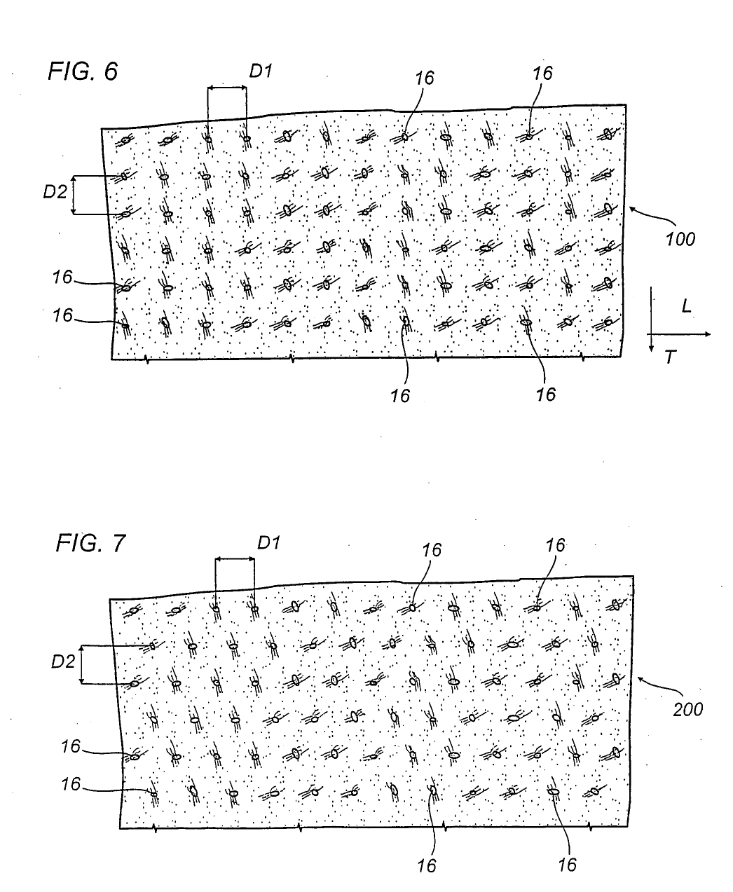

In a third preferred embodiment of the item according to the invention, illustrated in FIG. 6, the seeds 16 are not scattered at random but advantageously placed on the mat 100 at regular intervals to form rows with a predetermined spacing both longitudinally and transversally. The reference letters L and T in FIG. 6 conventionally denote the longitudinal and transversal directions, respectively.

In this preferred embodiment, the seeds are evenly distributed in the longitudinal direction, with a spacing D1 that may vary from 0.5 to 40 cm.

Similarly, in this preferred embodiment, the seeds are also evenly distributed in the transversal direction, with a spacing D2 that may vary from 0.5 to 40 cm.

Thus, ideal row spacing is obtained because the plants ate far enough apart to grow properly and flourish, and at the same time make full use of field space so that yields are optimised.

In traditional cultivating methods, sowing is performed mechanically by sowing machines which place the seeds directly in the soil much further apart since row spacing must be such as to allow the subsequent passage of personnel and machines employed to remove weeds.

Thanks to the mulching effect of the mat according to the present invention, there is no need for such wide row spacing since weeding operations are unnecessary, which means that the land can be cultivated more intensively and provides higher crop yields.

A fourth preferred embodiment 200 of the item according to the invention, illustrated in FIG. 7, is similar to the third preferred embodiment from which it differs in that the seeds are evenly distributed in longitudinal rows where the seeds in each longitudinal row are transversely offset from those of the adjacent longitudinal rows. Thus, as illustrated, seed spacing is such that each seed in one longitudinal row is positioned substantially half way along the distance between two seeds in the adjacent longitudinal row so as to form rows extending in a diagonal direction. This type of row spating provides optimum air space and growing conditions for seedlings.

The above are just some non-restricting examples of longitudinal row arrangements for the seeds or plant propagative structures in the mat and it will be understood that other types of spacing may be used. In another preferred embodiment, the mat is 150 cm wide with seeds arranged in longitudinal rows with a transversal spacing ranging from 20 to 35 cm between them.

Further, the mat might be made from a dark coloured material, since dark colours absorb the sunlight more readily and, by retaining heat, promote germination and plant growth in areas with cold climates or during seasons when temperatures remain quite low.

The substance used to colour the fabric from which the mat is made is preferably a natural colouring which does not negatively affect the biodegradability of the mat.

Conversely, in hot climates or during seasons when ambient temperatures may become very high, the mat might be made from a light coloured material, preferably white, to limit heating and reduce evaporation of water essential to seed germination.

The item according to the invention may also contain seeds of the following vegetables: artichokes, asparagus, cardoons, carrots, cabbages, cauliflowers, cucumbers, onions, fennels, beans, broad beans, endives, aubergines, melons, sweet peppers, peas, tomatoes, leeks, radishes, rocket, celery, spinach, lentils, parsnip, salsify, black salsify, cress, garlic, spinach beet, Swiss chard, watermelons, lettuces, parsley, chicory, turnips, valerians, pumpkins, courgettes, string beans and horseradish.

Further, the item according to the invention may also contain seeds of the following herbs and aromatic plants: basil, dianthus, great burdock, tarragon, ragged robin, calendula, chives, sedum, cumin, thyme, hot pepper, lemon balm, marjoram, rhubarb, nettle, mint, passion flower, aloe, oregano, vervain, chamomile, parsley, arnica, echinacea, rosemary, borage, poppy, sage, mallow, burnet saxifrage, savory, nepeta, lavender, eschscholtzia, plantain, coriander, helichrysum, belladonna, foxglove, galega, betony, phytolacca, woad, cardoon, fumitory, isatis, carline thistle, hyssop, pelargonium, greater celandine, botrychium lunaria, pennyroyal, marsh mallow, soapwort, santolina, motherwort, wild thyme, plantago psyllium, comfrey, lackspur, thorn apple, dill, valerianella, common tansy, achillea, flax, lovage, hypericum, grindelia, armeria, dandelion, meadowsweet, mugwort, ginger, common sorrel, field sorrel, garlic, lady's mantle, angelica, anis, columbine and absinth.

Compared to traditional field cultivating methods, where seeds are sown directly in the field, the item according to the invention gives a much higher seed germination yield. The seeds are placed in the mat in an optimum position for germination and, besides this, there is no risk of the seeds being eaten by birds or other animals or of ending up under a hard clod or too far under the surface or of being washed away by irrigation water.

Whereas the method described above for making the mat is a preferred embodiment of the method according to the invention, the mat, without departing from the scope of the invention, might also be placed top down during the manufacturing process, with the upper layer at the bottom, the seeds or other plant propagative structures placed over this and the mulching layer, including pellets or powder where necessary, placed at the top. In this case, the needles for needlepunching would be inserted from the bottom up.

The upper layer and/or the lower layer might also advantageously be made from the following textile fibres: raffia, nettle, hibiscus, Manila, gum, silk, wool, byssus, rayon, cupro, lyocell, modal, lanital-merinova, ardil-vicara-azlon.

It will be understood that the invention can be subject to modifications and variations without thereby departing from the scope of the inventive concept. Moreover, all the details of the invention may be substituted by technically equivalent elements.

1. An item for the cultivation of agricultural crops, in particular vegetables, herbs and aromatic plants, characterised in that it comprises a mat of biodegradable material having mulching properties and designed to be placed on the soil, the mat having incorporated in it a plurality of plant structures from which the agricultural crop grows or is propagated.

2. The item according to claim 1, characterised in that it comprises a layer (12) of biodegradable material having a lower surface constituting the face that comes into contact with the soil in which the crop plant grows.

3. The item according to claim 2, characterised in that it comprises a second layer (14) made of biodegradable material which during use, is placed over the first, soil contact layer and constitutes the means for retaining the plant propagative structures, and through which the plants grow above ground.

4. The item according to claim 2, characterised in that the lower layer (12) is made of a non-woven fabric.

5. The item according to claim 3, characterised in that the upper layer (14) is made of a non-woven fabric.

6. The item according to claim 3, characterised in that the lower layer (12) and/or the upper layer (14) is made of a viscose fibre.

7. The item according to claim 2, characterised in that the soil contact layer (12) weighs between 15 and 200 g/m².

8. The item according to claim 7, characterised in that the weight of the lower layer (12) ranges from 15 to 200 g/m², preferably from 30 to 150 g/m², and is made from a viscose fibre with a titre range of 1 to 6 dtex.

9. The item according to claim 7, characterised in that the weight of the lower layer (12) ranges from 10 to 200 g/m², preferably from 15 to 130 g/m², and is made from a viscose fibre with a titre range of 1.5 to 3.1 dtex.

10. The item according to claim 7, characterised in that the use of a soil contact layer (12) whose weight ranges from 50 to 100 g/m² is to be preferred, the ideal weight range being 80 to 100 g/m².

11. The item according to claim 3, characterised in that the plant structure retaining layer (14) weighs between 10 and 80 g/m².

12. The item according to claim 11, characterised in that the weight of the plant structure retaining layer (14) ranges from 15 to 100 g/m², with a viscose fibre having a titre range of 1 to 6 dtex.

13. The item according to claim 11, characterised in that the weight of the plant structure retaining layer (14) ranges from 10 to 90 g/m², with a viscose fibre having a titre range of 1.5 to 3.1 dtex.

14. The item according to claim 11, characterised in that the use of a plant structure retaining layer (14) whose weight ranges from 30 to 40 g/m² is preferable.

15. The item according to claim 1, characterised in that the mat, or at least one of the layers of the mat, is made from one of the following materials: flax, cotton, hemp, jute, cellulose acetate, elastodiene.

16. The item according to claim 1, characterised in that the plant propagative structures are preferably seeds from which the crop plants germinate.

17. The item according to claim 1, characterised in that the plant propagative structures are preferably seeds from which a broad-leaved plant grows directly from the root.

18. The item according to claim 1, characterised in that the mat has a dark or light colour.

19. The item according to claim 1, characterised in that the seeds or propagative plant structures are distributed in the mat in numbers of up to 8.000 seeds/m².

20. The item according to claim 3, characterised in that the seeds or propagative plant structures are placed at the upper surface (14b) of the mat or at the upper layer (14) of the mat.

21. The item according to claim 3, characterised in that the first non-woven fabric layer (12) and the second non-woven fabric layer (14) are joined to each other by needlepunching.

22. The item according to claim 1, characterised in that the seeds or plant propagative structures are distributed in the mat by random scattering or by alignment in parallel rows, that is to say, equally spaced at predetermined intervals.

23. The item according to claim 21 characterised in that during the needlepunching process, the needles penetrate from the top down, through the upper layer of the mat and into the lower, soil contact layer in such a way as to push the fibres of the upper layer into those of the lower layer, causing the seeds or plant propagative structures to be inserted into the upper layer.

24. The item according to claim 21, characterised in that needle density for the needlepunching process is between 2 and 1.500 needles inserted in each square centimetre of the mat.

25. The item according to claim 24, characterised in that needlepunching is performed preferably in such a way that approximately 120 needles are inserted in each square centimetre of the mat.

26. The item according to claim 1, characterised in that it comprises mulching material.

27. The item according to claim 1, characterised in that it comprises water retaining material.

28. The item according to claim 3, characterised in that it comprises interposed material between the first layer (12) and the second layer (14).

29. The item according to claim 26, characterised in that the material is of plant origin and in the form of pellets, powder or chippings and, in particular, is a plant meal.

30. The item according to claim 26, characterised in that the material is an inert material.

31. The item according to claim 26, characterised in that the material is a clay.

32. The item according to claim 26, characterised in that the material is bentonite.

33. The item according to claim 26, characterised in that the quantity of interposed pellet or powder material between the upper and lower layers of the mat ranges preferably from 10 to 700 g/m², and ideally from 10 to 400 g/m².

34. The item according to claim 1, characterised in that the mat, or at least one of the layers of the mat, is made from one of the following materials: abaca, sisal, cantala, ramie, coconut, caroa, kenaf, roselle, urena, kapok, broom, sorghum, raffia, nettle, hibiscus, Manila, gum, silk, wool, byssus, rayon, cupro, lyocell, modal, lanital-merinova, ardil-vicara-azlon.

35. The item according to claim 1, characterised in that the seeds or plant propagative structures (16) are distributed in the mat according to regular longitudinal and transversal spacing.

36. The item according to claim 1, characterised in that each seed or plant propagative structure (16) is placed at a substantially uniform distance from the seeds or plant propagative structures adjacent to it.

37. The item according to claim 1, characterised in that the seeds or plant propagative structures (16) are distributed in the mat according to longitudinal rows where each seed or plant propagative structure in one longitudinal row is positioned substantially half way along the distance between two seeds in the adjacent longitudinal row so as to form rows extending in a diagonal direction.

38. The item according to claim 1, characterised in that each seed or plant propagative structure is longitudinally spaced from the adjacent seeds in the longitudinal direction by a distance (D1) that may vary from 0.5 to 40 cm.

39. The item according to claim 1, characterised in that each seed or plant propagative structure is transversally spaced from the adjacent seeds in the transversal direction by a distance (D2) that may vary from 0.5 to 40 cm.

40. The item according to claim 1, characterised in that the mat is coloured with a natural colouring substance.

41. The item according to claim 1, characterised in that the plant propagative structures are preferably seeds of a vegetable plant species in the group comprising: lettuce, rocket, corn salad, valerian, endive, parsley, basil, carrot, asparagus, tomato, aubergine, courgette, cucumber, watermelon, melon, sage, spinach, rosemary, sweet pepper, cabbage, turnip, chicory, artichoke, peas, beans, string beans, radish, beet, cress, pumpkin, fennel, onion, leek;
or in the group comprising: artichokes, asparagus, cardoons, carrots, cabbages, cauliflowers, cucumbers, onions, fennels, beans, broad beans, endives, aubergines, melons, sweet peppers, peas, tomatoes, leeks, radishes, rocket, celery, spinach, lentils, parsnip, salsify, black salsify, cress, garlic, spinach beet, Swiss chard, watermelons, lettuces, parsley, chicory, turnips, valerians, pumpkins, courgettes, string beans and horseradish;
or plant propagative structures in the form of seeds of aromatic plants and herbs in the group comprising: basil, dianthus, great burdock, tarragon, ragged robin, calendula, chives, sedum, cumin, thyme, hot pepper, lemon balm, marjoram, rhubarb, nettle, mint, passion flower, aloe, oregano, vervain, chamomile, parsley, arnica, echinacea, rosemary, borage, poppy, sage, mallow, burnet saxifrage, savory, nepeta, lavender, eschscholtzia, plantain, coriander, helichrysum, belladonna, foxglove, galega, betony, phytolacca, woad, cardoon, fumitory, isatis, carline thistle, hyssop, pelargonium, greater celandine, botrychium lunaria, pennyroyal, marsh mallow, soapwort, santolina, motherwort, wild thyme, plantago psyllium, comf.rey, lackspur, thorn apple, dill, valerianella, common tansy, achillea, flax, lovage, hypericum, grindelia, armeria, dandelion, meadowsweet, mugwort, ginger, common sorrel, field sorrel, garlic, lady's mantle, angelica, anis, columbine and absinth.

42. A method for the production of an item for the cultivation of a vegetable crop, characterised in that it comprises the following steps: laying a layer of matting, placing the seeds or plant propagative structures (16) on the layer, and causing the seeds to become entangled in the mat.

43. The method according to claim 42, characterised in that a second layer (14) is laid over the seeds and in that the seeds are entangled in the matting by needlepunching.

44. The method according to claim 43, characterised in that needle density for needlepunching is between 2 and 1,500 needles inserted in each square centimetre of the mat and preferably in such a way that approximately 120 needles are inserted in each square centimetre of the mat.

45. The method according to claim 42, characterised in that prior to placing the seeds or plant propagative structures on the layer, a material (17) for insertion of the seeds or plant propagative structures is laid.
